(19) United States
(12) Patent Application Publication
(10) Pub. No.: US 2007/0122045 A1
(43) Pub. Date: May 31, 2007

(54) SYSTEM FOR SCALING A PICTURE UNIT FROM A FIRST VIDEO RESOLUTION FORMAT TO A SECOND VIDEO RESOLUTION FORMAT

(76) Inventor: Jiun-Yuan Wu, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 11/379,232

(22) Filed: Apr. 19, 2006

Related U.S. Application Data
(60) Provisional application No. 60/597,421, filed on Nov. 29, 2005.

(51) Int. Cl. G06K 9/36; G06K 9/46; G06K 9/32

(52) U.S. Cl. 382/233; 382/298

(57) ABSTRACT

A system for scaling a picture unit from a first video resolution format to a second video resolution format, the picture unit being encoded utilizing a specific encoding scheme, is disclosed. The system includes: a FIFO, for buffering an encoded bit stream of the PU; a decoding circuit, coupled to the FIFO, for receiving the encoded bit stream of the PU, and decoding the encoded bit stream to generate a plurality of pixel data; a scaling circuit, coupled to the decoding circuit and the FIFO, for controlling the decoding circuit to duplicate at least a pixel data according to a scaling factor of the first video resolution format to the second video resolution format; and a look-up table, coupled to the scaling circuit and the decoding circuit, containing a plurality of values corresponding to the pixel data.

### CROSS REFERENCE TO RELATED APPLICATIONS

This application claims the benefit of U.S. Provisional Application No. 60/597,421, which was filed on Nov. 29, 2005 and is included herein by reference.

### BACKGROUND

Digital discs have revolutionized home television, providing users with crystal clear pictures and a ‘home theatre’ experience. DVD is a standard definition (SD) format, displaying 30 frames a second, where each frame consists of 480 interlaced horizontal lines (known as 480i), or 480 progressive horizontal lines (known as 480p) according to the NTSC standard. As TV screen sizes increase, however, a standard definition picture shows some weaknesses, such as visible lines and flickering images.

Manufacturers therefore developed a next generation format known as high definition (HD) television. HD comes in various formats: two of the most common are 720p, where each frame consists of 720 progressive horizontal lines; and 1080i, where each frame consists of 1080 interlaced horizontal lines.

When viewing DVD on an HDTV it is necessary to scale the picture to fit the size (i.e. the resolution) of the television screen. If this is done incorrectly it can interfere with the aesthetics of the picture—for example, objects can appear stretched too far in one direction than the other.

### SUMMARY

The present invention provides a method for scaling a picture unit (PU) from a first video resolution format to a second video resolution format, the PU being encoded utilizing a specific encoding scheme.

Briefly described, a first embodiment of the apparatus comprises: a FIFO, for buffering an encoded bit stream of the PU, wherein the PU is encoded utilizing a run-length encoding; a decoding circuit, coupled to the FIFO, for receiving the encoded bit stream of the PU, and run-length decoding the encoded bit stream to generate a plurality of run-length data; a scaling circuit, coupled to the decoding circuit and the FIFO, for controlling the decoding circuit to duplicate at least a run-length data according to a scaling factor of the first video resolution format to the second video resolution format; and a look-up table, coupled to the scaling circuit and the decoding circuit, containing a plurality of color values corresponding to the run-length data.

A second embodiment of the apparatus comprises: a FIFO, for buffering an encoded bit stream of the PU, wherein the PU is encoded utilizing a pixel encoding; a decoding circuit, coupled to the FIFO, for receiving the encoded bit stream of the PU, and pixel decoding the encoded bit stream to generate a plurality of pixel data; a scaling circuit, coupled to the decoding circuit and the FIFO, for controlling the decoding circuit to duplicate at least a pixel data according to a scaling factor of the first video resolution format to the second video resolution format; and a look-up table, coupled to the scaling circuit and the decoding circuit, containing a plurality of values corresponding to the pixel data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an apparatus for scaling a picture unit (PU) from a first video resolution format to a second video resolution format according to a first embodiment of the present invention.

FIG. 2 is a diagram of an apparatus for scaling a picture unit (PU) from a first video resolution format to a second video resolution format according to a second embodiment of the present invention.

### DETAILED DESCRIPTION

Certain terms are used throughout the following description and claims to refer to particular system components. As one skilled in the art will appreciate, consumer electronic equipment manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

Converting a video format from SD to HD requires manipulation of various parameters. The location and associated color of every pixel has to be calculated so a new, scaled image can be built up. A first scaling technique is interpolation, which include various techniques such as line doubling, statistical prediction, and curve fitting; a second technique is feature extraction, which includes motion estimation, and motion adaptation.

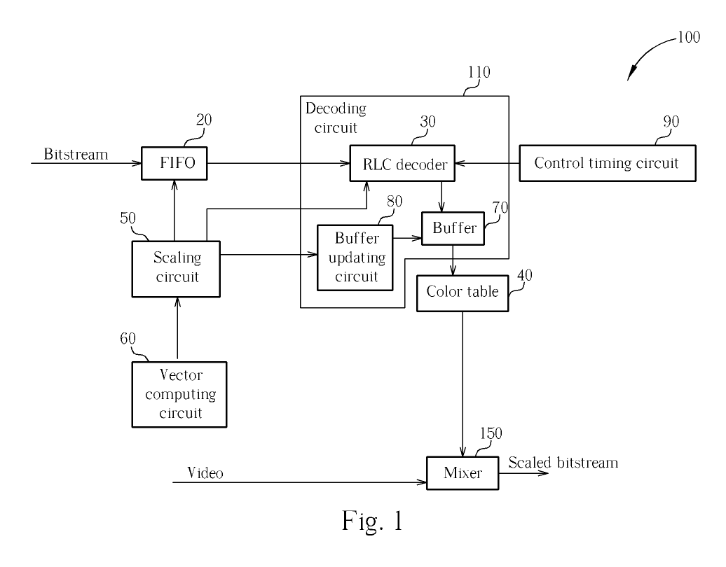

Please refer to FIG. 1. FIG. 1 is a diagram of an apparatus 100 for scaling a picture unit (PU) from a first video resolution format to a second video resolution format, the PU being encoded utilizing a run-length encoding scheme.

The apparatus 100 comprises a FIFO 20 that receives and buffers the bit stream and outputs it to a decoding circuit 110, which contains a run-length code (RLC) decoder 30. The FIFO 20 is coupled to a scaling circuit 50, which is also coupled to the decoding circuit 110. The RLC decoder 30 decodes the data stream received from the FIFO 20 to generate a plurality of pixel data (i.e. run-length data), and sends the decoded data stream to a buffer 70, also contained in the decoding circuit 110. The output of the RLC decoder 30 in this embodiment is clocked by a control timing circuit 90. The scaling circuit 50 is coupled to a vector computing circuit 60, which determines a scaling vector according to the ratio of the second video resolution format (e.g. 1080i) to the first video resolution format (e.g. 480i). The scaling circuit 50 accesses the RLC decoder 30 to determine how many pixels of information exist in a picture unit (PU) of the data stream, then inputs this number and the scaling vector into an equation to determine how many pixels a scaled PU should comprise. The scaling circuit 50 then utilizes this result to drive a buffer updating circuit 80 in the decoding circuit 110. The buffer updating circuit 80 controls the buffer 70 to output its data a plurality of times, so the same run-length data (e.g. color information) is repeatedly output. This data is input to a color table 40, which enables color conversion of the data. In this way, a PU having an increased number of pixels at each horizontal scan line can be constructed under the control of the buffering updating circuit 80, wherein the increased number of pixels at each horizontal scan line enables the scaled PU to accurately fit a second video resolution format. The color converted data is finally sent to a mixer 150, for transmitting the converted data stream (i.e. the scaled bit stream) to another device, e.g. an HDTV.

In the first embodiment, the incoming bitstream is compressed using a run-length encoded format. In the encoded format a unit of information consists of two bytes. The first byte indicates how many pixels are contained and the second byte indicates the color of the pixels. The color index contained in the second byte is determined by accessing the color table 40, which contains YCbCr values corresponding to each pixel. Thereafter, the YCbCr values can be converted to RGB values for display. Therefore, by run-length decoding a picture unit (PU) utilizing the RLC decoder 30 the number of pixels in the PU can be accurately determined.

The pixel information is then input to the scaling circuit 50, which inputs the pixel information in the PU into an equation to determine a scaling vector for the PU. The equation is:
A=B×Scaling vector

Where: A=number of pixels required for second video resolution format

B=number of pixels in first video resolution format

Scaling vector=ratio of second video resolution format to first video resolution format

The scaling circuit 50 utilizes this information to determine how many times run-length data will be output from the buffer 70 to the color table 40. Outputting the run-length data a plurality of times is equivalent to increasing the number of pixels at a horizontal scan line of the PU, and thereby achieves the goal of scaling the PU.

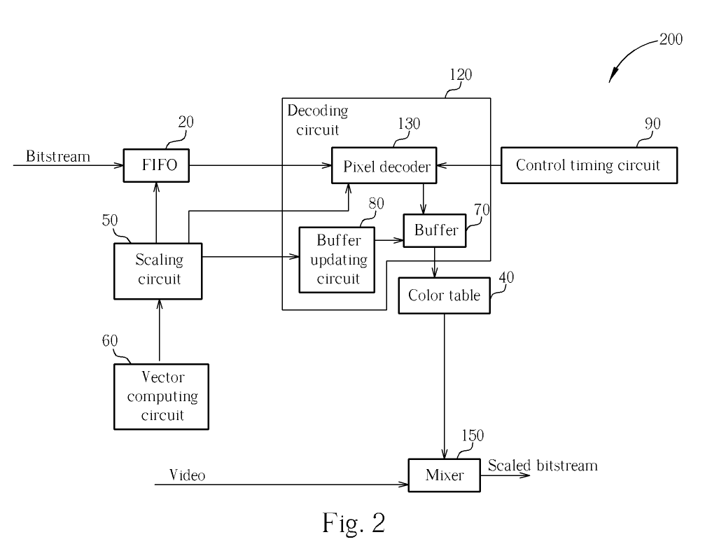

Please note that the method of decoding does not need to be a run-length code decoding method. In an absolute encoding mode, the first byte of a unit of information is set to zero and the second byte is set to a value that indicates how many bytes will follow. Each byte contains the color index of a single pixel. Therefore, by utilizing a pixel decoding scheme, a similar result as that described above can be obtained. Please refer to FIG. 2. FIG. 2 is a diagram of an apparatus 200 for converting a PU from a first video resolution format to a second video resolution format according to a second embodiment. As can be seen from FIG. 2 many elements have the function as elements of the same name in FIG. 1. As such, these elements have been given the same numerals as in FIG. 1 to avoid confusion. The apparatus 200 is largely similar to the apparatus 100 of FIG. 1, but the apparatus 200 replaces the RLC decoder 30 with a pixel decoder 130. The pixel decoder 130 is coupled to a buffer 70, which is further coupled to a color table 40. In a similar way to the apparatus 100, the scaling circuit obtains the number of pixels in the PU by accessing the pixel decoder 130, and then utilizes this number and the scaling vector obtained by the vector computing circuit 60 to calculate a scaling factor. After the buffer updating circuit 80 controls the buffer 70 to output the buffered data a plurality of times according to the scaling factor, the duplicate of the buffered data will be input to the look-up table 40, and then an output of the look-up table 40 is sent to the mixer 150 for producing the scaled bitstream meeting requirements of a display device, e.g. an HDTV.

As mentioned above, the scaling is performed by duplicating the pixel data (e.g. the color index) output from the RLC decoder/pixel decoder instead of manipulating the output generated from referencing the color table. Therefore, the memory requirement in this embodiment is reduced because color index generated from the RLC decoder/pixel decoder, compared to the output of the color table, has smaller bit length. In short, the system of the present invention advantageously scales a PU by utilizing a simple decoding scheme.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A system for scaling a picture unit (PU) from a first video resolution format to a second video resolution format, the PU being encoded utilizing a specific encoding scheme, the system comprising:
a decoding circuit, for receiving an encoded bit stream of the PU, and decoding the encoded bit stream to generate a plurality of pixel data; and
a scaling circuit, coupled to the decoding circuit, for controlling the decoding circuit to duplicate at least a pixel data according to a scaling factor of the first video resolution format to the second video resolution format.

2. The system of claim 1, wherein the PU is encoded utilizing a run-length encoding, and the decoding circuit performs a run-length decoding on the encoded bit stream.

3. The system of claim 2, further comprising:
a vector computing circuit, coupled to the scaling circuit, for determining a scaling vector of the first video resolution format to the second video resolution format;
wherein the scaling circuit references the scaling vector and a run-length information retrieved by the decoding circuit to determine the scaling factor.

4. The system of claim 1, further comprising:
a control timing circuit, coupled to the decoding circuit, for clocking an output of the decoding circuit.

5. The system of claim 1, wherein the decoding circuit comprises:
a decoder;
a buffer, coupled to the decoder, for buffering an output of the decoder; and
a buffer updating circuit, coupled to the buffer and controlled by the scaling circuit, for controlling the buffer to output the output of the decoder a plurality of times.

6. The system of claim 5, further comprising:
a look-up table, coupled to the scaling circuit and the decoding circuit, containing a plurality of values corresponding to the pixel data.

7. The look-up table of claim 6, wherein the plurality of values are color indexes representing a color of each pixel.

8. A system for scaling a picture unit (PU) from a first video resolution format to a second video resolution format, the PU being encoded utilizing a specific encoding scheme, the system comprising:
a FIFO, for buffering an encoded bit stream of the PU;
a decoding circuit, coupled to the FIFO, for receiving the encoded bit stream of the PU, and decoding the encoded bit stream to generate a plurality of pixel data;
a scaling circuit, coupled to the decoding circuit and the FIFO, for controlling the decoding circuit to duplicate at least a pixel data according to a scaling factor of the first video resolution format to the second video resolution format; and
a look-up table, coupled to the scaling circuit and the decoding circuit, containing a plurality of values corresponding to the pixel data.

9. The system of claim 8, wherein the PU is encoded utilizing a run-length encoding, and the decoding circuit performs a run-length decoding on the encoded bit stream.

10. The system of claim 9, further comprising:
a vector computing circuit, coupled to the scaling circuit, for determining a scaling vector of the first video resolution format to the second video resolution format;
wherein the scaling circuit references the scaling vector and a run-length information retrieved by the decoding circuit to determine the scaling factor.

11. The system of claim 8, further comprising:
a control timing circuit, coupled to the decoding circuit, for clocking an output of the decoding circuit.

12. The system of claim 8, wherein the decoding circuit comprises:
a decoder;
a buffer, coupled to the decoder, for buffering an output of the decoder; and
a buffer updating circuit, coupled to the buffer and controlled by the scaling circuit, for controlling the buffer to output the output of the decoder a plurality of times.

13. The look-up table of claim 8, wherein the plurality of values are color indexes representing a color of each pixel.
